(19) United States
(12) Patent Application Publication
(10) Pub. No.: US 2005/0046135 A1
(43) Pub. Date: Mar. 3, 2005

(54) Mobile rocking seating device

(76) Inventor: Stanley Secretan, Leona Valley, CA (US)

Correspondence Address: STANLEY SECRETAN, 40014 95ST WEST, LEONA VALLEY, CA, 93551, US

(21) Appl. No.: 10/652,935

(22) Filed: Sep. 2, 2003

(51) Int. Cl. B62B 7/00

(52) U.S. Cl. 280/47.41

(57) ABSTRACT

A mobile rocking seating device with wheels attached to upper and lower frames connected together by leaf springs which maintain the seat in a generally horizontal position with adjustable seat back angle allowing the user to rock themselves as in a conventional rocking chair or propel themselves with their feet when leaning forward or be pushed by others.

### BACKGROUND OF THE INVENTION

Rocking chairs have been available to all for many years providing a comfortable place to sit and enjoy body movement for health reasons or comfort. The mobile rocking seating device invention provides the benefits of the conventional rocking chair plus the added benefit of being able to propel oneself with hands free (foot support retracted) or be pushed by a care giver with the foot support in place. A conventional wheelchair has large costly wheels mounted outside its main frame. Rocking wheel chair U.S. Pat. No. 5,004,259 shows such a device. Said rocking wheel chair has large drive wheels and can fall backwards (the rear wheel axle is high up and close to the occupants body mass) when rocked vigorously, thus requiring the addition of anti-tip safety devises to be installed behind the drive wheels. Many seniors and others do not have the strength or coordination needed to operate wheel driven wheel chairs but do have considerable leg and foot strength although not able to stand for prolonged periods of time. This low cost mobile rocking seating device has the feature of having the rear wheel axles placed close to the ground and well aft of the occupants body mass making it impossible to fall backwards even with very vigorous rocking action. Also the said device being foot propelled has a huge advantage of being substantially narrower then a conventional wheel chair since the wheels are located within the device frame allowing hands free access through narrow crowded areas or sitting at a dinner table. Generally the said device presents more of a comfortable chair appearance rather then that of a cumbersome wheel chair.

It is common knowledge that body movement is vital for good health. The activity available when using the said invention for users of all ages from handicapped kids playing basketball from their chair to senior citizens propelling themselves from place to place in a nursing home is of great health value to the user.

### SUMMARY OF THE INVENTION

The crux of this invention lies in having leaf springs (Reference U.S. Pat. No. 4,119,343) provide rocking action to a seating device that is mounted on wheels spaced in front of and behind the occupant providing a stable, low cost, good looking platform from which the occupant can rock and roll. Leaning forward the user can easily propel the mobile rocking seating device by using their feet pushing either forward or backward. A storable foot support rotated in place with the occupants feet placed on it allows another to push the occupant seated in the mobile rocking seating device. Locking the easy-to-reach rear wheel anti rotation member wheel locks provides a stable platform on a inclined surface or retains the occupant in a fixed position allowing vigorous rocking for, as example, over active kids using up excess energy. Placing the backrest at a adjustable angle provides various comfortable seating positions. With the back rest at its greatest angle a rocking seating device occupant's heart is in a less vertical position then sitting straight which while rocking can be very helpful for recovering heart patents.

### DESCRIPTION OF THE DRAWINGS

FIG. 1 shows a perspective view from the front of the present mobile rocker seating device invention.

FIG. 2 shows a perspective view of the back of the present mobile rocker seating device invention.

FIG. 3 shows a perspective view of the underside of the mobile rocker seating device invention

FIG. 4 shows a perspective view from the front of the present invention with the seat back folded in the stowage position and the foot support rotated in the under seat position.

FIG. 5 shows a enlarged fragmentary view of the wheel anti rotation member off position

FIG. 6 shows a enlarged fragmentary view of the wheel anti rotation member on position.

FIG. 7 shows a enlarged fragmentary view of the seat back notched latch.

FIG. 8 shows a enlarged fragmentary view of the foot rest support stop member.

### THE PREFERRED EMBODIMENT

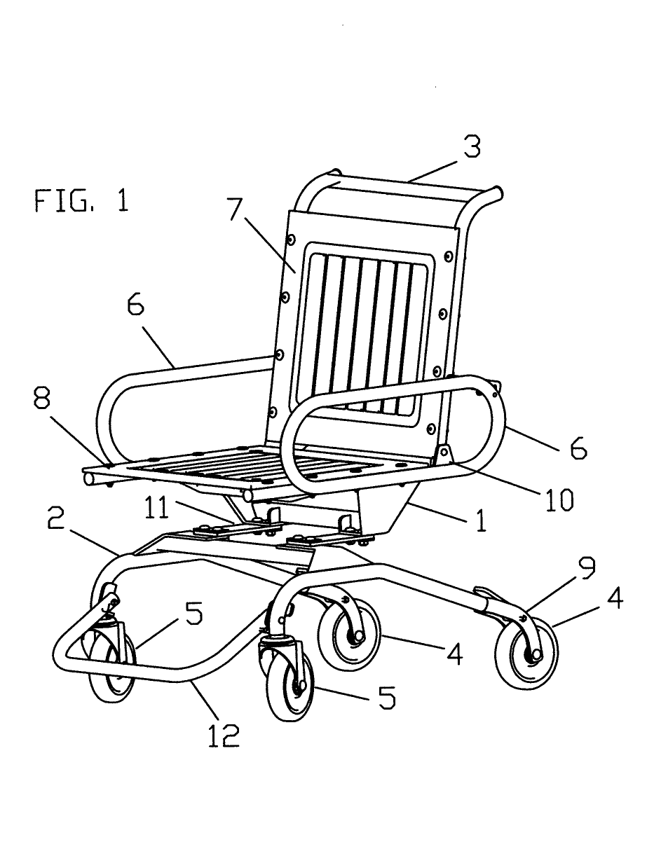

Reference to FIG. 1 shows a mobile rocking seating device having upper seat frame 1 and a lower wheel frame 2 adjoined to each other by leaf springs 11. The said leaf springs 11 form a flexible joint between the upper frame 1 and lower frame 2 which allows the seat 8 to pivot about the bending axis of the said leaf springs 11.

The lower wheel frame 2 as seen in FIGS. 1,2 and 3 is a tubular steel gusset reinforced welded assembly. Leaf spring 11 mounting plates form the cross member of the lower wheel frame. Bent metal forks 9 are mounted aft on each side of the lower wheel frame with axles for wheels 4. Forward on the lower wheel frame on each side is a downwardly open receptacle for caster assemblies 5.

The upper frame 1 as seen in FIGS. 1,2 and 3 is a tubular steel gusset reinforced welded assembly. Leaf spring 11 mounting plates form the cross member of the upper frame 1 with mounting surfaces for stretched seat upholstery 8. Arm rest loops 6 are attached to the upper frame at a slight outward angle with respect to the seat upholstery providing space for the user.

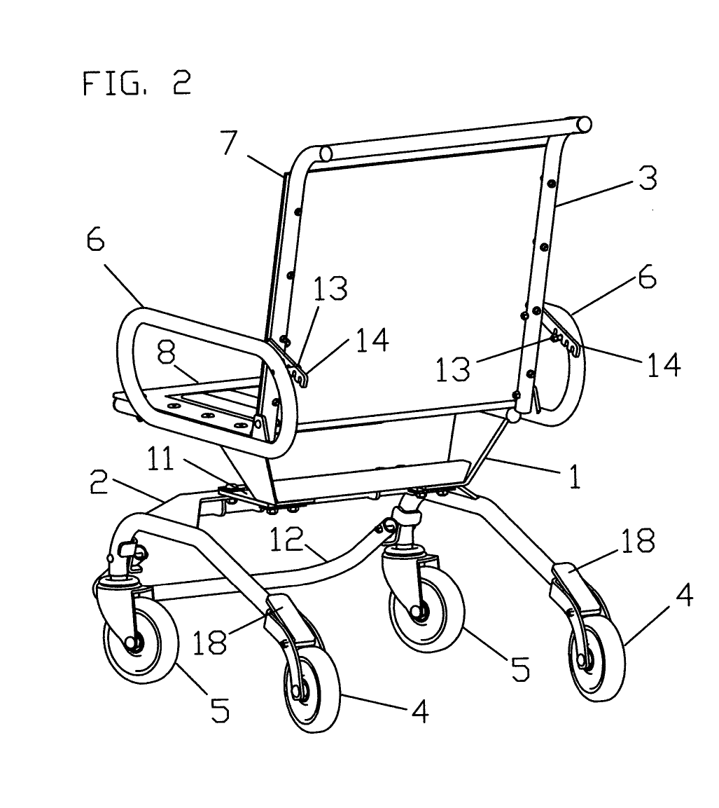

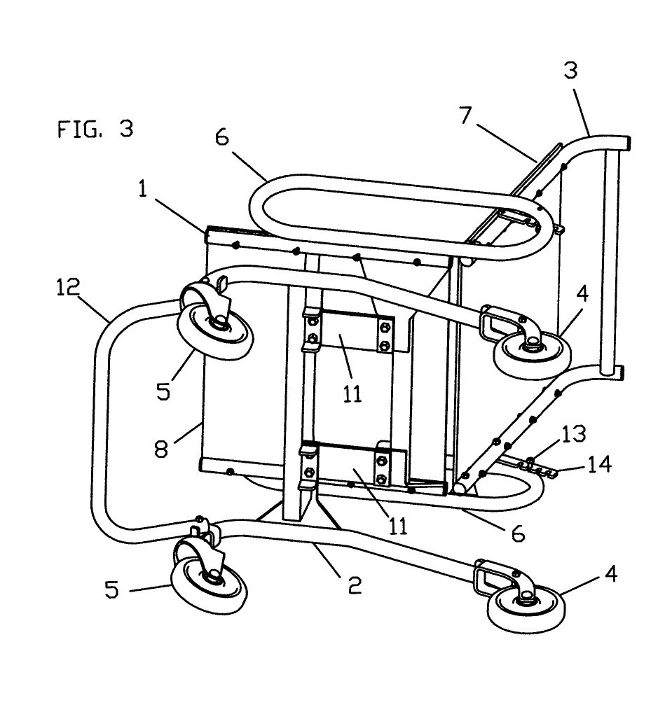

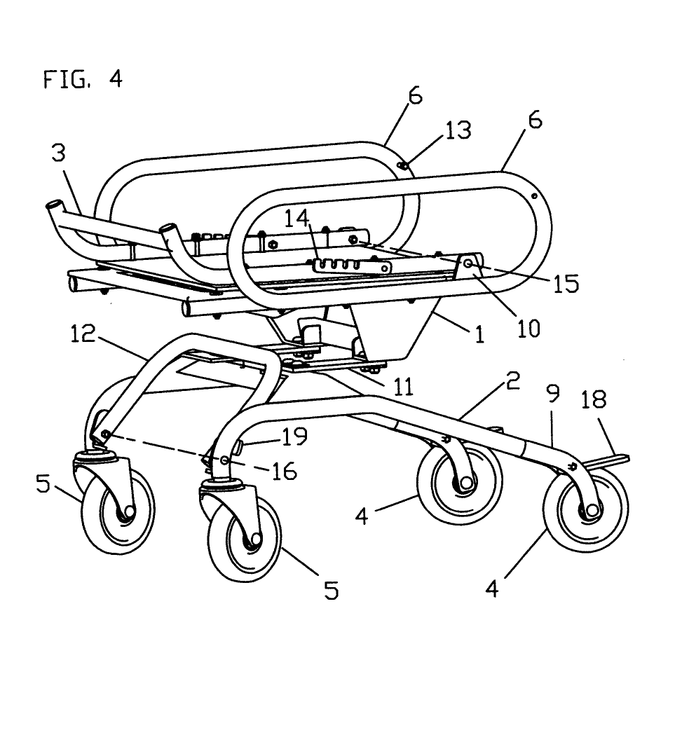

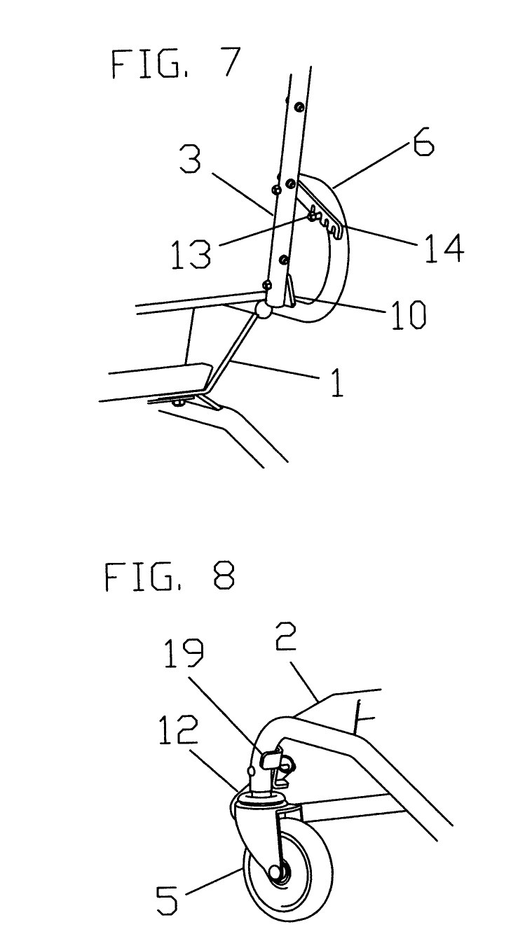

Arm rest loops as seen in FIG. 1 have upwardly extending members 10 which provide mounting points for the seat back 3. The seat back is allowed to pivot about axis 15 seen in FIG. 4. The seat back position is either in the stowed position as seen in FIG. 4 or in one of several locked upright positions. As seen in FIGS. 2 and 7 notched latches 14 mounted to each side of seat back frame 3 latch onto pins 13 in any of the several upright positions allowing the seat back to recline with respect to the seat upholstery 8.

As seen in FIG. 1 seat back frame 3 provides stretched mounting for seat back upholstery 7.

In FIGS. 1,2, and 3 is seen the foot support 12 in the user position. Foot support 12 pivots about axis 16 as seen in FIG. 4 on shafts mounted in lower frame 2. In user position the foot support rests on stops 19 as seen in FIGS. 1 and 8. The stops 19 which rests in turn against lower frame 2 are of heavy metal and are allowed to pivot about axis 16 as the foot rest is placed in the stowed position as seen in FIG. 4.

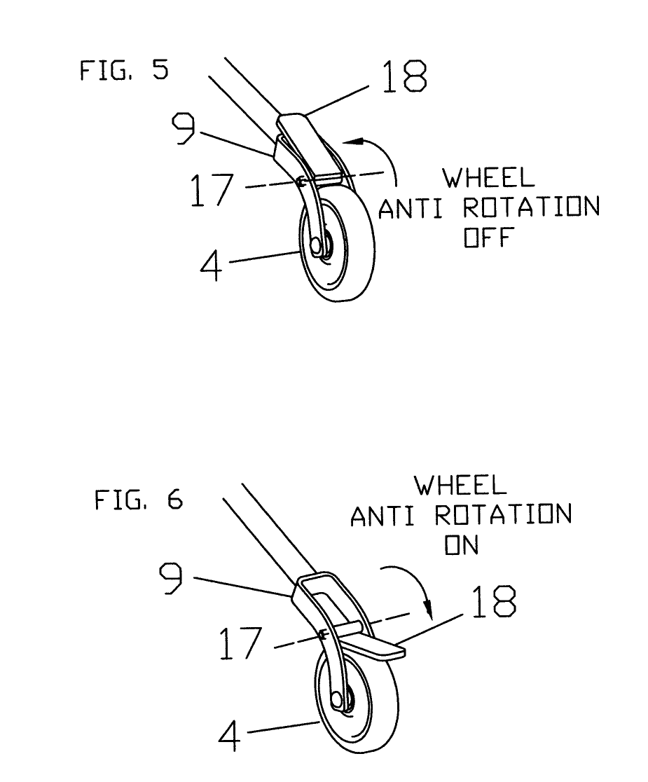

Referring now to FIGS. 5 and 6 wheel anti rotation member 18 is shown in locked on position FIG. 5 and wheel anti rotation off position FIG. 6. Anti rotation member 18 is a flat plate welded to a tube which pivots about axis 17 as seen in FIGS. 5 and 6. The clearance space between the wheel tread and axis 17 is less then the thickness of member 18 causing a interference condition between the anti rotation member and the flexible tire tread of wheel 4 locking the wheel in place.

Although but one specific embodiment of this invention is herein shown and described, it will be understood that details of the construction, as welded steel construction, may be altered with different materials as reinforced plastics or omitted without departing from the spirit of the invention as defined by the claims 1, 2 and 3.

1. A mobile rocking seating device that permits the occupant to rock while seated in said device as well as propel oneself by using their feet and pushing themselves along on the ground
(a) a upper seat frame formed of two reinforced spaced apart seat upholstery supports
(b) a lower wheel frame connecting a aft pair of wheels with said seat frame formed of two reinforced spaced apart wheel supports
(c) a pair of caster wheels pivotally connected forward to said lower wheel frame
(d) a rocking assembly of two leaf springs adjoining said seat frame in a forward-aft rocking relationship to said lower wheel frame
(e) said leaf springs mounted horizontally, their length, width and thickness determined by the amplitude of rocking desired for a given weight person, thus the said mobile rocking seating device can be structured to be suitable for light weight as well as heavy users
(f) a seat back upholstery support pivotally attached to said upper seat frame in such a manor as to allow adjustment of seat to back angle, further the said seat back cross strength member provides a pushing member for others to move the mobile rocking seating device about
(g) said seat back upholstery support being pivotally attached to said lower seat frame can be pivoted forward for compact said mobile rocking seating device stowage
(h) arm rest loop attached to each side of said seat frame providing said mobile rocking seating device occupant arm support as well as support for said seat back to said seat frame
(i) two notched support members pivotally attached on each side of said seat back, each with one of several said support member notches placed on a projection attached to each said arm rest loops providing adjustable angle support to said seat back

2. A mobile rocking seating device heretofore recited in claim 1 wherein said mobile rocking seating device further comprises a occupant foot support
(a) a tubular member pivotally attached to said lower wheel frame as to allow rotating from foot support position to under the said upper seat frame for storage when not used
(b) a stop member between said foot support and said lower wheel frame wheel support to stop said foot support when rotated to user position.

3. A mobile rocking seating device as recited in claim 1 wherein said mobile rocking seating device further comprises a pair of removable aft wheel anti rotation devices
(a) a flat member pivotally attached aft to said lower wheel frame in which the occupant can rotate said member from free a wheeling position to a anti rotation wheel position, a off center pivot hole allows slight compression of the aft wheel elastic tire as said flat member snaps on to the wheel surface causing anti rotation action of said wheel.
